(19) United States
(12) Patent Application Publication
(10) Pub. No.: US 2017/0206843 A1
(43) Pub. Date: Jul. 20, 2017

(54) DISPLAY DEVICE AND DRIVING METHOD THEREOF

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yingming Liu, Beijing (CN); Xue Dong, Beijing (CN); Haisheng Wang, Beijing (CN); Xiaochuan Chen, Beijing (CN); Weijie Zhao, Beijing (CN); Changfeng Li, Beijing (CN); Xiaoliang Ding, Beijing (CN); Hongjuan Liu, Beijing (CN); Shengji Yang, Beijing (CN); Wei Liu, Beijing (CN); Lei Wang, Beijing (CN)

(73) Assignees: BOE Technology Group Co., Ltd., Beijing (CN); Beijing BOE Optoelectronics Technology Co., Ltd., Beijing (CN)

(21) Appl. No.: 15/326,609

(22) PCT Filed: Dec. 23, 2015
(86) PCT No.: PCT/CN2015/098481

§ 371 Date: Jan. 16, 2017

(30) Foreign Application Priority Data
Jul. 9, 2015 (CN) 201510401162.0

(51) Int. Cl. G09G 3/34; G06K 9/00; G09G 3/20; G09G 3/36; G09G 3/3208

(52) U.S. Cl. CPC G09G 3/3413; G09G 3/3607; G09G 3/3208; G09G 3/2003; G06K 9/00087; G06K 9/0004; G09G 2300/0452; G09G 2300/023

(57) ABSTRACT

A display device and a driving method for the same are provided in embodiments of the present application. the display device includes: a LCD panel without a color filter layer, the LCD panel comprising a plurality of first pixel units arranged into an array, each first pixel unit comprising at least three sub-pixels, each sub-pixel comprising a display unit, at least one sub-pixel of each of the plurality of first pixel units being provided with a palmprint identification unit for palmprint identification; and a light source disposed at a light-incident side of the LCD panel and configured for providing light of three-primary colors to three sub-pixels of the at least three sub-pixels respectively, the three sub-pixels comprising the at least one sub-pixel provided with the palmprint identification unit. The driving method is used for the display device having a palmprint identification function.

### CROSS-REFERENCE TO RELATED APPLICATIONS

This application is a Section 371 National Stage Application of International Application No. PCT/CN2015/098481, filed on 23 Dec. 2015, entitled “DISPLAY DEVICE AND DRIVING METHOD THEREOF”, which claims priority to Chinese Application No. 201510401162.0, filed on 9 Jul. 2015, incorporated herein by reference in its entirety.

### TECHNICAL FIELD

Embodiments of the present application relate to the field of palmprint identification technology, and especially, to a display device and its driving method.

### BACKGROUND

Liquid crystal displays (LCD) have advantages such as low irradiation, small volume, low energy consumption and the like, and are widely used in electronic devices such as tablet computers, TV sets, mobile phones and the like. A LCD mainly includes a backlight and a display panel, and its principle of display lies in that: after the light emitted by the backlight arrives at the display panel, a voltage difference between a pixel electrode and a common electrode in each sub-pixel of the display panel controls a deflection angle of liquid crystals, so as to control an intensity of light emitted from the sub-pixel; a grayscale of colored light emitted from each sub-pixel can be determined according to a color of a color filter layer in a corresponding sub-pixel and the intensity of light emitted from the sub-pixel.

Further, palmprint identification technology, which is developed by Hong Kong Polytechnic University and Tsinghua University in later stage of 90's of the 20th century, has been widely used.

However, in palmprint identification, light of three-primary colors emitted from the liquid crystal display are utilized as an identification light source, and when palmprint identification technology is applied in a LCD, natural light emitted from the backlight includes light of various wavelengths, which may adversely affect accuracy of palmprint identification and degrade performance of palmprint identification.

### SUMMARY

Embodiment of the present application provides a display device and its driving method, which may partially alleviate the problem of bad performance of palmprint identification caused by natural light emitted from the backlight of prior art.

In order to achieve such an objective, the following technical solutions are provided by embodiments of the present application.

In one aspect of the present application, there is provided a display device.

According to an exemplary embodiment, the display device comprises: a LCD panel without a color filter layer, the LCD panel comprising a plurality of first pixel units arranged into an array, each first pixel unit comprising at least three sub-pixels, each sub-pixel comprising a display unit, at least one sub-pixel of each of the plurality of first pixel units being provided with a palmprint identification unit for palmprint identification; and a light source disposed at a light-incident side of the LCD panel and configured for providing light of three-primary colors to three sub-pixels of the at least three sub-pixels respectively, the three sub-pixels comprising the at least one sub-pixel provided with the palmprint identification unit.

According to a further exemplary embodiment, the light source comprises an OLED display panel; and the OLED display panel comprises a plurality of second pixel units arranged into an array, and each of the plurality of second pixel units comprises a red sub-pixel, a green sub-pixel and a blue sub-pixel.

According to a still further exemplary embodiment, the plurality of first pixel units and the plurality of second pixel units are arranged in one-to-one correspondence.

According to a still further exemplary embodiment, sub-pixels of the plurality of first pixel units provided with palmprint identification units and blue sub-pixels of the plurality of second pixel units are arranged in one-to-one correspondence.

According to a still further exemplary embodiment, each second sub-pixel of the OLED display panel comprises an anode, a cathode, and a light-emitting layer arranged between the anode and the cathode; and the red sub-pixel comprises a red light-emitting layer, the green sub-pixel comprises a green light-emitting layer, and the blue sub-pixel comprises a blue light-emitting layer.

According to a still further exemplary embodiment, the LCD panel and the OLED display panel are connected with each other via optical clear resin adhesive.

According to a still further exemplary embodiment, the LCD panel further comprises an array substrate and an opposite substrate, and the display unit is arranged on the array substrate.

According to a still further exemplary embodiment, the palmprint identification unit is arranged on the array substrate and comprises a photosensitive transistor.

In another aspect of the present application, there is provided a driving method for the display device according to any one of the above embodiments.

According to an exemplary embodiment, the driving method comprises: controlling the plurality of second pixel units of the OLED display panel to emit light, and charging the display units of the plurality of first pixel units of the LCD panel to control light exitance; and controlling palmprint identification units to collect palmprint information.

According to a further exemplary embodiment, controlling the plurality of second pixel units of the OLED display panel to emit light comprises controlling the plurality of second pixel units of the OLED display panel to emit light row by row; and charging the display units of the plurality of first pixel units of the LCD panel comprises charging display units in a row of first pixel units corresponding to a row of second pixel units that are emitting light.

According to a still further exemplary embodiment, controlling palmprint identification units to collect palmprint information comprises controlling palmprint identification units in the row of first pixel units that are emitting light to collect palmprint information.

Embodiments of the present application provide a display device and a driving method thereof, which utilize an OLED light source to provide a LCD panel with light of three-primary colors, such that the LCD panel may perform a color display without a color filter layer; and, since a palmprint identification unit is integrated within the LCD panel, the display device has a palmprint identification function; based on the above, since the OLED light source itself emits light of three-primary colors, such as red light, green light and blue light, the display device according to the embodiment of the present application may, as compared with backlight in prior art that emits natural light, alleviate the problem of bad performance of palmprint identification caused by natural light emitted from the backlight.

### BRIEF DESCRIPTION OF THE DRAWINGS

In order to describe embodiments of the present application or technical solutions in prior arts more clearly, drawings that are used for describing the embodiments or prior arts will be briefly introduced. Apparently, only a few embodiments of invention are shown in the drawings, based on which a person of ordinary skill may obtain other drawings obviously.

FIG. 1 is a first schematic view showing a structure of a display device according to an embodiment of the present application;

FIG. 2 is a second schematic view showing a structure of a display device according to an embodiment of the present application;

FIG. 3 is a third schematic view showing a structure of a display device according to an embodiment of the present application;

FIG. 4 is a schematic view showing a structure of a second pixel unit of an OLED display panel according to an embodiment of the present application;

FIG. 5 is a schematic view showing a structure of a display unit of an OLED display panel according to an embodiment of the present application;

FIG. 6 is a schematic view showing a structure of a palmprint identification unit of an OLED display panel according to an embodiment of the present application;

FIG. 7 is a flow chart showing a driving method for a display device according to an embodiment of the present application.

### LIST OF REFERENCE NUMERALS

01—LCD panel
02—OLED light source
03—OLED display panel
10—first pixel unit
11—first sub-pixel
12—second sub-pixel
101—display unit
102—palmprint identification unit
30—second pixel unit
31—red sub-pixel
32—green sub-pixel
33—blue sub-pixel
301—anode
302—cathode
303—red light-emitting layer
304—green light-emitting layer
305—blue light-emitting layer
1011—switching transistor
1012—pixel electrode
1013—common electrode
SL—gate line
DL—data line
T1—first transistor
T2—second transistor
Scan—scanning line
RL—reading line
V1—control voltage terminal

### DETAILED DESCRIPTION OF PREFERRED EMBODIMENTS

Technical solutions provided in embodiments of the present application will be described clearly and thoroughly with reference to the appended drawings. Apparently, only a few—not all—embodiments of invention are shown in the drawings. All other embodiments obtained obviously by a person of ordinary skill in the art based on the embodiments of this disclosure shall fall within the scope of the present application.

Unless otherwise defined, all technical terms and scientific terms used herein should be interpreted as having their general meaning. Terms “first”, “second” and the like used in the description and claims of the present disclosure only used to distinguish different components and do not intend to indicate or imply any order, number or importance. Similarly, terms “a”, “an” or the like does not imply a limitation to a specific number, but meaning that at least one such thing exists. Term “connect”, “connection” or like is not limited to a physical connection or a mechanical connection, it can also be an electrical connection, directly or indirectly.

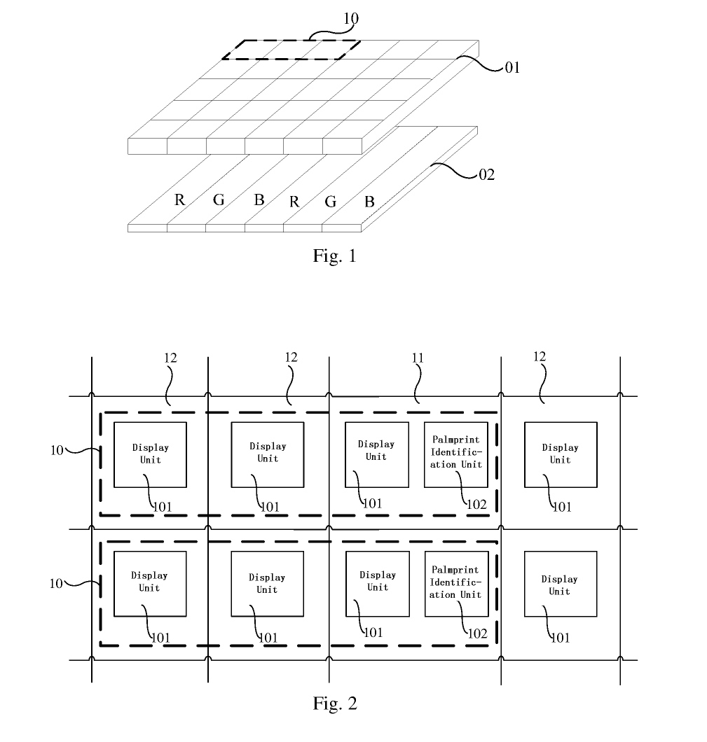

A display device is provided in an embodiment of the present application. As shown in FIG. 1, the display device includes a LCD panel 01 provided with no color filter layer, and the LCD panel 01 includes a plurality of first pixel unit 10 arranged into an array, each of the first pixel units includes at least three sub-pixels, and each sub-pixel includes a display unit; at least one of the sub-pixels in each of the first pixel unit 10 is provided with a palmprint identification unit for identifying a palmprint. The display device further includes a light source 02 arranged at a light-incident side of the LCD panel, and the light source 02 is used to provide light of three-primary colors to the at least three sub-pixels of each first pixel unit 10.

The light source 02 may be, for example, an Organic Light-Emitting Diode (OLED) light source.

To be noted, first, the first pixel unit 10 may include at least three sub-pixels, and in a condition that the first pixel unit 10 only includes three sub-pixels, the light source 02 may provide the three sub-pixels of the first pixel unit 10 with light of three-primary colors respectively; and in a condition that the first pixel unit 10 includes more than three sub-pixels, the light source 02 may provide three of the sub-pixels of the first pixel unit 10 with light of three-primary colors respectively, and at least one of the three of the sub-pixels includes the palmprint identification unit. On the basis of the above, other sub-pixels of the first pixel unit 10 except the three sub-pixels may be provided with light according to practical requirement, and the light may be, for example, white light and is not specifically limited.

Second, the embodiment of the present application is described assuming that each first pixel unit 10 only includes three sub-pixels and one of the three sub-pixels includes a palmprint identification unit. To facilitate description, a sub-pixel including both of a display unit 101 and a palmprint identification unit 102 will be named as a first sub-pixel 11, and other sub-pixels which include only a display unit 101 and does not include a palmprint identification unit 102 will be named as a second sub-pixel 12, as shown in FIG. 2.

Third, the light of three-primary colors may include, for example, red (R) light, green (G) light and blue (B) light. Of course, it may also include cyan (C) light, magenta (M) light and yellow (Y) light instead. The embodiment of the present application is described taking the light of three-primary colors being red light, green light and blue light for example.

Based on the above, the OLED light source 02 may include a plurality of sets of light sources of three primary colors, each set of light sources of three primary colors may include a sub-light source emitting red light, a sub-light source emitting green light and a sub-light source emitting blue light.

Fourth, since the LCD panel 01 is provided with no color filter layer, in order to realize a color display of the LCD panel 01, each first pixel unit 10 should be able to receive red light, green light and blue light emitted by the OLED light source 02 during each frame.

On the basis of the above, a structure of the display unit 101 in each sub-pixel of the first pixel unit 10 is not specifically limited herein, as long as it can realize a display function.

Further, a structure of the palmprint identification unit 102 is also not specifically limited herein, as long as it can realize a palmprint identification function.

As described above, the embodiment of the present application has provided a display device, which utilizes a light source 02 to provide the LCD panel 01 with light of three-primary colors, such that the LCD panel 01 may perform a color display without a color filter layer; moreover, since the palmprint identification unit 102 is integrated within the LCD panel 01, the display device has a palmprint identification function; based on the above, since the OLED light source 02 itself emits light of three-primary colors, such as red light, green light and blue light, the display according to the embodiment of the present application may, as compared with backlight in prior art that emits natural light, alleviate the problem of bad performance of palmprint identification caused by natural light emitted from the backlight.

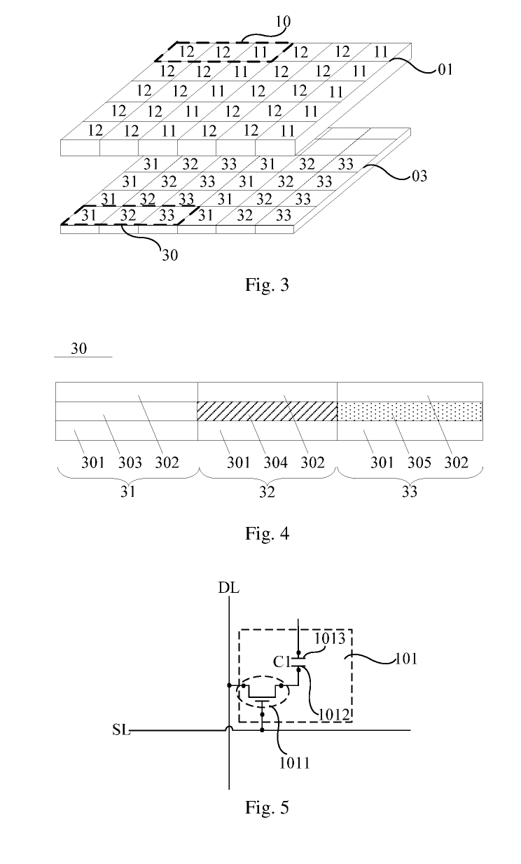

In a preferred embodiment, as shown in FIG. 3, the light source 02 includes an OLED display panel 03, the OLED display panel 03 includes a plurality of second pixel units 30 arranged into an array, and each of the second pixel units 30 includes a red sub-pixel 31, a green sub-pixel 32 and a blue sub-pixel 33.

As shown in FIG. 4, the red sub-pixel 31, the green sub-pixel 32 and the blue sub-pixel 33 each may include an anode 301, a cathode 302 and a light-emitting layer. Specifically, the light-emitting layer in the red sub-pixel 31 is a red light-emitting layer 303, the light-emitting layer in the green sub-pixel 32 is a green light-emitting layer 304 and the light-emitting layer in the blue sub-pixel is a blue light-emitting layer 305.

Furthermore, each of the red sub-pixel 31, the green sub-pixel 32 and the blue sub-pixel 33 may also include an electron transfer layer and a hole transfer layer besides the light-emitting layer for emitting light of a corresponding color. Moreover, in order to further improve an efficiency of electron injection and hole injection into the light-emitting layer, each of the sub-pixels may further include an electron injection layer arranged between the cathode and the electron transfer layer and a hole injection layer arranged between the anode and the hole transfer layer.

In the embodiment of the present application, in order to facilitate a manufacturing process, anodes of all the sub-pixels in the OLED display panel 03 may be connected together (i.e., they share a common anode); of course, cathodes of all the sub-pixels may also be connected together (i.e., they share a common cathode); or, anodes of all the sub-pixels may be connected together and cathodes of all the sub-pixels may be connected together simultaneously.

Or, anodes of sub-pixels having the same color (for example, the red sub-pixels 31 or the green sub-pixels 32 or the blue sub-pixels 33) and arranged in the same column in the OLED display panel 03 may be connected together, anodes of sub-pixels arranged in different columns are not connected together; on the basis of the above, cathodes of all sub-pixels may be connected together.

Or, anodes of sub-pixels having the same color in the OLED display panel 03 may be connected together, and additionally, cathodes of all sub-pixels may be connected together.

In the embodiment of the present application, on one hand, since color and intensity of light emitted by each sub-pixel may be accurately controlled by the OLED display panel 03, the display unit 101 in each sub-pixel of the LCD panel 01 may be provided with a light source of three primary colors, such that the LCD panel 01 may have a better display performance; on the other hand, since a light-emitting region may also be controlled by the OLED display panel 03, light may be provided only to palmprint identification units 102 within a region covered by a palm during a palmprint identification stage, such that a time period needed for the palmprint identification may be reduced and unnecessary interferences may be avoided.

In a further preferred embodiment, as shown in FIG. 3, the first pixel units 10 and the second pixel units 30 are arranged in one-to-one correspondence.

That is, three sub-pixels in one first pixel unit 10 correspond to the red sub-pixel 31, the green sub-pixel 32 and the blue sub-pixel 33 in a corresponding second pixel unit 30 respectively.

In such a manner, when first pixel units 10 arranged in one row are turned on, the three sub-pixels in each of the first pixel units 10 may receive red light, green light and blue light emitted by three sub-pixels of a corresponding second pixel unit 30 simultaneously and respectively and may emit the lights simultaneously and respectively so as to realize a color display.

Further, considering that, among red light, green light and blue light, blue light is the one that is influenced by external environment the least, thus preferably in the embodiment of the present application, the first sub-pixels 11 (i.e., the sub-pixels that include the palmprint identification units 102) of the first pixel units in the LCD panel 01 are arranged in one-to-one correspondence with the blue sub-pixels 33 in the OLED display panel 30.

Preferably, the LCD panel 01 and the OLED display panel 03 are connected with each other via optical clear resin (OCR) adhesive.

That is, the LCD panel 01 and the OLED display panel 03 are fixed together by the OCR adhesive, so as to form the display device. Usage of the OCR adhesive may avoid an influence to light transmissivity.

Based on the above, further preferably, the LCD panel 01 may also include an array substrate and an opposite substrate, and of course, it also includes a liquid crystal layer located between the array substrate and the opposite substrate; the display unit 102 is arranged on the array substrate.

Refer to FIG. 5, the display unit 101 may include a switching transistor 1011, a pixel electrode 1012 electrically connected to a drain electrode of the switching transistor, and a common electrode 1013. The thin film transistor includes a gate, a gate insulation layer, a semiconductor active layer, a source and a drain, the drain is connected with the pixel electrode. Of course, the array substrate further includes a gate line SL connected with the gate and a data line DL connected with the source. The gate line is connected with display units 101 of sub-pixels arranged in a row, and the data line is connected with display units of sub-pixels arranged in a column.

Specifically, for an In-Plane Switch (IPS) type array substrate, the pixel electrode and the common electrode are arranged in the same layer and spaced apart from one another, and each of the pixel electrode and the common electrode is a strip-shaped electrode; for an Advanced-super Dimensional Switching (ADS) type array substrate, the pixel electrode and the common electrode are arranged in different layers, one of the pixel electrode and the common electrode located on top is a strip-shaped electrode, and the other one is a plate-shaped electrode. Additionally, the opposite substrate includes a black matrix.

Further preferably, the palmprint identification unit 102 is also located on the array substrate, and palmprint identification unit includes at least a photosensitive transistor, through which valley lines and ridge lines of a palmprint may be identified. In such a manner, the palmprint identification unit 102 may be manufactured simultaneously with the display unit 101, so as to simplify a manufacturing process.

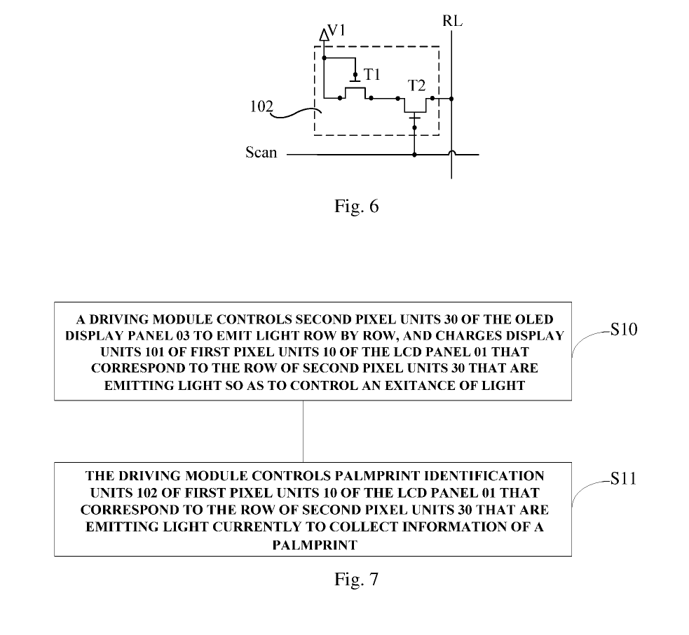

Exemplarily, as shown in FIG. 6, the palmprint identification unit 102 may include a first transistor T1 and a second transistor T2, the first transistor is a photosensitive transistor; a gate electrode and a first electrode of the first transistor T1 are connected with a control voltage terminal V1, a second electrode of the first transistor is connected with a first electrode of the second transistor T2; a gate electrode of the second transistor T2 is connected with a scanning line Scan, a second electrode of the second transistor is connected with a reading line RL for sending collected palmprint information to a corresponding receiving device so as to process the palmprint information.

An embodiment of the present application further provides a driving method for the display device according to the foregoing embodiment. For example, the display device may be driven by a driving module in the display device. As shown in FIG. 7, the driving method includes the following steps.

In step S10, a driving module controls second pixel units 30 of the OLED display panel 03 to emit light row by row, and charges display units 101 of first pixel units 10 of the LCD panel 01 that correspond to the row of second pixel units 30 that are emitting light so as to control an exitance of light.

In this embodiment, through controlling a charging process of the display units 101, deflection angle of liquid crystals may be controlled, such that an intensity of light emitted by the second pixel units 30 after passing through the first pixel units 10 of the LCD panel 01 may be controlled.

A way of driving the OLED display panel may be a row-by-row driving, a column-by-column driving, or the like. Preferably, the OLED display panel is driven row by row to emit light, which may reduce an influence on a pixel from light emitted by adjacent pixels, such that accuracy of identification may be improved.

In step S11, the driving module controls palmprint identification units 102 of first pixel units 10 of the LCD panel 01 that correspond to the row of second pixel units 30 that are emitting light currently to collect information of a palmprint.

Specifically, in a condition of the palmprint identification unit 102 including a photosensitive transistor, when the palmprint identification unit 102 is collecting information of a palmprint, the light emitted by the second pixel units 30 of the OLED display panel 03 should be ensured to be able to pass through the first pixel units 10 of the LCD panel 01 to arrive at the palm, because a palmprint identification performed by the photosensitive transistor is based on the light incident to the palm and reflected back to the photosensitive transistor. Based on the above, palmprint information collection may be performed by the palmprint identification unit 102 synchronously with normal display of the LCD panel 01.

Or, the controls may be performed asynchronously. For example, the OLED display panel and the LCD panel may be driven at two different stages. In a first stage of a frame, the second pixel units 30 of the OLED display panel 03 are controlled to emit light and the display units 101 of the first pixel units 10 of the LCD panel 01 are charged to control an exitance of light, such that a frame of image is displayed by the LCD panel 01. In a second stage of the frame, as discussed above, the palmprint identification units 102 are controlled to collect palmprint information while the OLED display panel and the LCD panel are being driven. Therefore, in the second stage, the LCD panel 01 may display normally or display a white picture.

In the second stage, if a path of light emitted by second pixel units 30 arranged in a first row, after passing through corresponding first pixel units 10 of the LCD panel 01 that correspond to the second pixel units 30, is deflected due to reflection from a palm, palmprint identification units 102 in first pixel units 10 arranged in a corresponding row (such as a second row) to which the light is reflected may be utilized to identify the palmprint; similarly, after the light emitted by second pixel units 30 arranged in a second row has passed through corresponding first pixel units 10 of the LCD panel 01 that correspond to the corresponding second pixel units 30, palmprint identification units 102 in first pixel units 10 arranged in a corresponding row (such as a third row) to which the light is reflected may be utilized to identify the palmprint; and so on.

It is to be noted that, in order to avoid interference between signals, the first stage and the second stage may be different time periods, and lengths of time of the first stage and the second stage may also be different.

Additionally, the first stage and the second stage may be in the same frame. That is, each frame repeats the first stage and the second stage.

Based on the above, through repeating the first stage and the second stage, an object of performing palmprint identification during display may be achieved.

Exemplarily, it is assumed that a scan frequency is 60 Hz, i.e., each frame lasts for 16.67 milliseconds (ms). Time period for one frame is divided into two stages. In the first stage, the second pixel units 30 of the OLED display panel 03 are controlled by the driving module to emit light row by row, and the display units 101 of the first pixel units 10 of the LCD panel 01 corresponding to the row of the second pixel units 30 that are emitting light are charged, so as to accomplish display of a frame of an image. In the second stage, the second pixel units 30 of the OLED display panel 03 are controlled by the driving module to emit light row by row, the display units 101 of the first pixel units 10 of the LCD panel 01 which correspond to a row of the second pixel units 30 that are emitting light are charged to display a white picture, and at the same time, the palmprint identification units 102 of first pixel units 10 corresponding to the row of the second pixel units 30 that are emitting light are controlled by the control module to collect palmprint information to accomplish a palmprint identification. Lengths of time periods for the two stages may be identical or different.

With the driving method for display device according to the embodiment of the present application, the OLED display panel 03 is utilized to provide light of three-primary colors to the LCD panel 01 row by row, such that the LCD panel 01 may perform a color display without a color filter layer and may be prevented from being interfered; moreover, since the LCD panel 01 is integrated with the palmprint identification units 102, the display device thereby has a palmprint identification function; based on the above, since the OLED display panel 03 itself may emit light of three-primary colors row by row, as compared with a prior art backlight that emits natural light, the method according to the embodiment of the present application may avoid an influence from natural light emitted by a backlight and may improve accuracy of identification greatly.

Although exemplary embodiments of the present application are described, the scope of the present application is not limited thereto. All modification or changes that are obvious to a person of ordinary skill in this art shall fall within the scope of this disclosure. Therefore, the scope of the present application is defined by the appended claims and its equivalents.

1. A display device, comprising:
a LCD panel without a color filter layer, the LCD panel comprising a plurality of first pixel units arranged into an array, each first pixel unit comprising at least three sub-pixels, each sub-pixel comprising a display unit, at least one sub-pixel of each of the plurality of first pixel units being provided with a palmprint identification unit for palmprint identification; and
a light source disposed at a light-incident side of the LCD panel and configured for providing light of three-primary colors to three sub-pixels of the at least three sub-pixels respectively, the three sub-pixels comprising the at least one sub-pixel provided with the palmprint identification unit.

2. The display device according to claim 1, wherein the light source comprises an OLED display panel; and
wherein the OLED display panel comprises a plurality of second pixel units arranged into an array, and each of the plurality of second pixel units comprises a red sub-pixel, a green sub-pixel and a blue sub-pixel.

3. The display device according to claim 2, wherein the plurality of first pixel units and the plurality of second pixel units are arranged in one-to-one correspondence.

4. The display device according to claim 3, wherein sub-pixels of the plurality of first pixel units provided with palmprint identification units and blue sub-pixels of the plurality of second pixel units are arranged in one-to-one correspondence.

5. The display device according to claim 2, wherein each sub-pixel of each second sub-pixel unit of the OLED display panel comprises an anode, a cathode, and a light-emitting layer arranged between the anode and the cathode; and
wherein the red sub-pixel comprises a red light-emitting layer, the green sub-pixel comprises a green light-emitting layer, and the blue sub-pixel comprises a blue light-emitting layer.

6. The display device according to claim 2, wherein the LCD panel and the OLED display panel are connected with each other via optical clear resin adhesive.

7. The display device according to claim 1, wherein the LCD panel further comprises an array substrate and an opposite substrate, and the display unit is arranged on the array substrate.

8. The display device according to claim 7, wherein the palmprint identification unit is arranged on the array substrate and comprises a photosensitive transistor.

9. A driving method for the display device according to claim 2, comprising:
controlling the plurality of second pixel units of the OLED display panel to emit light, and charging the display units of the plurality of first pixel units of the LCD panel to control light exitance; and
controlling the palmprint identification unit to collect palmprint information.

10. The driving method according to claim 9,
wherein controlling the plurality of second pixel units of the OLED display panel to emit light comprises controlling the plurality of second pixel units of the OLED display panel to emit light row by row; and
wherein charging the display units of the plurality of first pixel units of the LCD panel comprises charging the display units in a row of first pixel units corresponding to a row of second pixel units that are emitting light.

11. The driving method according to claim 10, wherein controlling the palmprint identification unit to collect palmprint information comprises controlling the palmprint identification unit of first pixel units that correspond to a row of second pixel units that are emitting light to collect palmprint information.
